(19) United States
(12) Patent Application Publication
(10) Pub. No.: US 2024/0296713 A1
(43) Pub. Date: Sep. 5, 2024

(54) STREAMING BETTING GAME METHOD AND SYSTEM

(71) Applicant: VOLCANO DIVER INC., LAS VEGAS, NV (US)

(72) Inventor: Ki Young NAM, Seongnam-si (KR)

(21) Appl. No.: 18/571,805

(22) PCT Filed: Jun. 21, 2022
(86) PCT No.: PCT/KR2022/008757

§ 371 Date: Dec. 20, 2023

(30) Foreign Application Priority Data
Jun. 21, 2021 (KR) 10-2021-0080248

(51) Int. Cl. G07F 17/32

(52) U.S. Cl. CPC G07F 17/3225; G07F 17/3279; G07F 17/3288

(57) ABSTRACT

A streaming betting game system and method are provided. The streaming betting game method may include configuring a user pool for creating a match play; selecting a match play user who can establish the match play with a current user from the user pool; creating a game instance from among games stored in a game repository; streaming the game instance along with a play image of an opponent to the matched user; and determining wins and losses or priority from game results and performing rewards.

### TECHNICAL FIELD

The disclosure relates to a streaming betting game method and system.

### BACKGROUND ART

Game streaming technology that allows users to enjoy games without having a separate game consoles or installing game applications in their devices is attracting attention. To this end, game streaming technology may stream game data from a game cloud or a game source device to a user device equipped with a screen, and transmit a user input received from the user device during a game play to the game cloud or the game source device. For example, when the user device is a smartphone equipped with a touch screen, the game play may be possible by displaying game data streaming from the game cloud on the touch screen and transmitting a gesture input that a user inputs through the touch screen to the game cloud without installing a separate game application in the smartphone. Besides, several users may enjoy a match play in which the users compete with each other while playing the same streaming game.

### DISCLOSURE

### Technical Problem

The present disclosure attempts to provide a streaming betting game method and system capable of allowing a plurality of users to bet on a streaming game and enjoy a match play.

### Technical Solution

A streaming betting game method according to an embodiment may include configuring a user pool for creating a match play; selecting a match play user who can establish the match play with a current user from the user pool; creating a game instance from among games stored in a game repository; streaming the game instance along with a play image of an opponent to the matched user; and determining wins and losses or priority from game results and performing rewards.

In some embodiments, the method may further include storing additional information for view configuration received from the game instance as a separate metafile in a match repository; and streaming play images stored in the match repository to a user device along with a streaming game.

In some embodiments, the streaming may include configuring a screen including two or more images in a picture in picture or split screen format; and streaming a configured final image to the user device.

In some embodiments, the selecting of the match play user may include selecting users who can establish a match play based on ELO rating.

In some embodiments, the selecting of the match play user may include selecting a target pool based on ELO points and selecting the optimal user from among users belonging to the selected target pool by considering a quantified game streaming status.

In some embodiments, the streaming of the game instance along with the play image of the opponent may include streaming the game instance along with statuses of a plurality of opposing players based on areas created by an algorithm that a game creator has previously determined and need to be at least shared with other players and areas created by the algorithm that the game creator has previously determined and need to be seen by a player when playing a game.

In some embodiments, the method may further include reconfiguring an image captured by a camera included in a user device of each user and sharing the reconfigured image with other users.

In some embodiments, the selecting of the match play user may include periodically or aperiodically inspecting at least one of a communication status between a user device and a streaming game cloud, a status of the user device, a status of a game instance from a game start stage, and selecting an optimal opponent found by quantifying a status value.

In some embodiments, the selecting of the match play user may include correcting skill scores by matching players with similar latency.

A computer-readable medium according to an embodiment may record a program on a computer for executing configuring a user pool for creating a match play; selecting a match play user who can establish the match play with a current user from the user pool; creating a game instance from among games stored in a game repository; streaming the game instance along with a play image of an opponent to the matched user; and determining wins and losses or priority from game results and performing rewards.

### DESCRIPTION OF THE DRAWINGS

FIG. 1 is a diagram for explaining a streaming betting game system according to an embodiment.

FIG. 2 is a diagram for explaining a streaming betting game method according to an embodiment.

FIG. 3 is a diagram for explaining a streaming betting game system according to an embodiment.

FIG. 4 is a diagram for explaining a streaming betting game system according to an embodiment.

FIG. 5 is a diagram for explaining an operation of a streaming betting game system according to an embodiment.

FIG. 6 is a diagram for explaining an operation of a streaming betting game system according to an embodiment.

FIG. 7 is a diagram for explaining a streaming betting game system according to an embodiment.

FIG. 8 is a diagram illustrating a computing device for implementing a streaming betting game system and method according to embodiments.

### MODE FOR INVENTION

With reference to the attached drawings, embodiments of the present invention will be described in detail below so that ordinary skilled in the art may easily implement the present invention. However, the present invention may be implemented in many different forms and is not limited to the embodiments described herein. In order to clearly explain the present invention in the drawings, parts irrelevant to the description are omitted, and like reference numerals designate like elements throughout the specification.

Throughout the specification and the claims, unless explicitly described to the contrary, the word “comprise”, and variations such as “comprises” or “comprising”, may be understood to imply the inclusion of stated elements but not the exclusion of any other elements.

The terms such as “-portion”, “-group”, “module”, and “means” described in the specification may mean a unit that processes at least one function or operation described in the specification, which may be implemented as hardware or software or a combination of hardware and software.

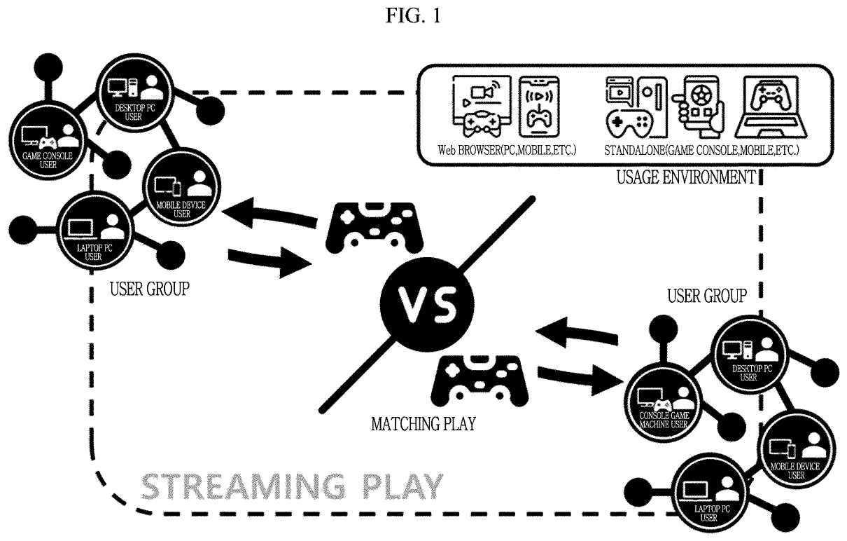

FIG. 1 is a diagram for explaining a streaming betting game system according to an embodiment.

Referring to FIG. 1, the streaming betting game system according to an embodiment may provide a matching play for a plurality of user groups playing games in various usage environments.

Specifically, the plurality of user groups may include a first user group and a second user group. The first user group and the second user group may each include, for example, a console game machine user, a desktop PC user, a laptop PC user, and a mobile device user. Here, at least some of the desktop PC user, the laptop PC user, and the mobile device user may play games in a web browser-based usage environment, and the console game machine user, the desktop PC user, the laptop PC user, and the mobile device user may play games in a standalone-based usage environment. The streaming betting game system according to an embodiment may provide, for example, the matching play between the mobile device user belonging to the first user group that plays games in the web browser-based usage environment, and the console game machine user belonging to the second user group that plays games in the standalone-based usage environment.

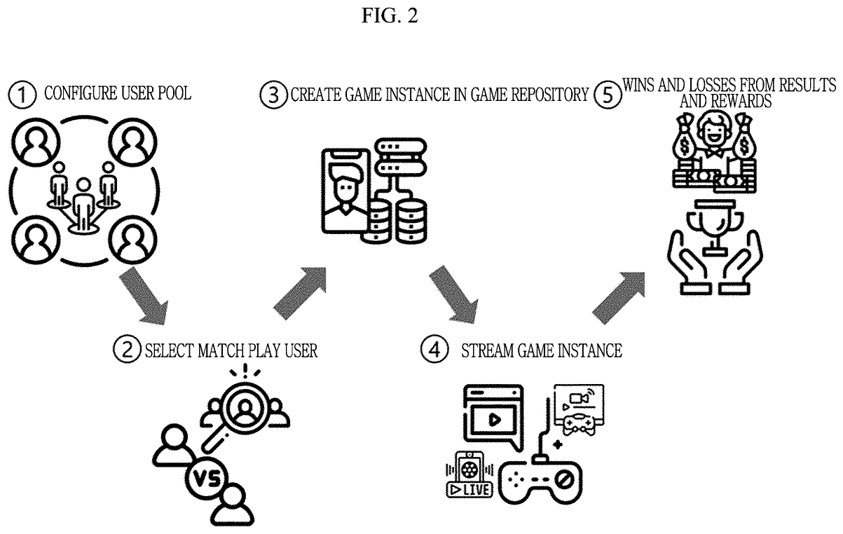

FIG. 2 is a diagram for explaining a streaming betting game method according to an embodiment.

Referring to FIG. 2, the streaming betting game method according to an embodiment may include configuring a user pool for creating a match play; selecting a match play user who can establish the match play with a current user from the user pool; creating a game instance from among games stored in a game repository; streaming the game instance along with a play image of an opponent to the matched user; and determining wins and losses or priority from game results and performing rewards.

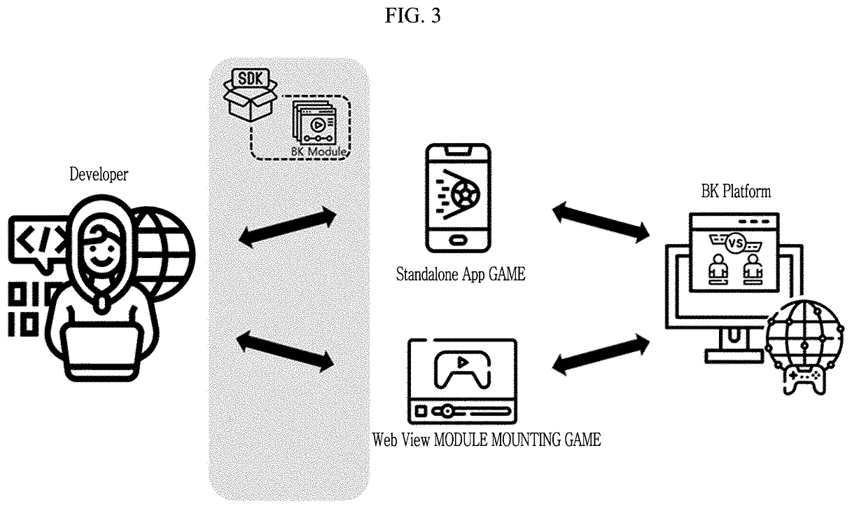

FIG. 3 is a diagram for explaining a streaming betting game system according to an embodiment.

Referring to FIG. 3, the streaming betting game system according to an embodiment may include a match platform (“BK Platform”) of a streaming game cloud. The match platform may be connected to a user device to provide a match play.

A game application may or may not be installed on the user device. When the game application is installed on the user device, a user may play a game through a standalone app (“Standalone App”). In this case, the user may download and install the standalone app from app markets (“App Markets”), and the standalone app may have been built to include a match module (“BK Module”) to provide a web view module for the match play of multiple users. To this end, a software development kit (SDK) may be provided to a developer (“Developer”). Unlike this, the user may play a streaming game through a web portal (“Web Portal”) without installing the game application on the user device. In this case, a method of providing the streaming game to the user is not limited to a method through the web portal, and may include any method that can be implemented by ordinary skill in the art to which the present invention pertains.

The web view module may provide the match play between multiple users when multiple users are all playing the game through the standalone app, when multiple users are all playing the game through the web portal, or when some of multiple users are playing the game through the standalone app, and the others are playing the game through the web portal. A match between multiple users may be made through the match platform (“BK Platform”) of the streaming game cloud.

In addition, the web view module may transmit user inputs that multiple users input for a game play to the streaming game cloud to allow a streaming game to operate.

In addition, the web view module may transmit a result of recognizing a game score of the user or arbitrary data that allows the game score to be recognized from a game state (e.g., a game screen) in which multiple users are playing to the streaming game cloud. For example, when a match is made between a user playing the streaming game and a user playing the standalone app, in the former case the streaming game cloud itself may decide the game score, but in the latter case it is not a streaming environment, and thus, data for determining the game score may be transmitted from the user device to the streaming game cloud, and the streaming game cloud may determine the game score based on the data and then determine wins and losses or ranking.

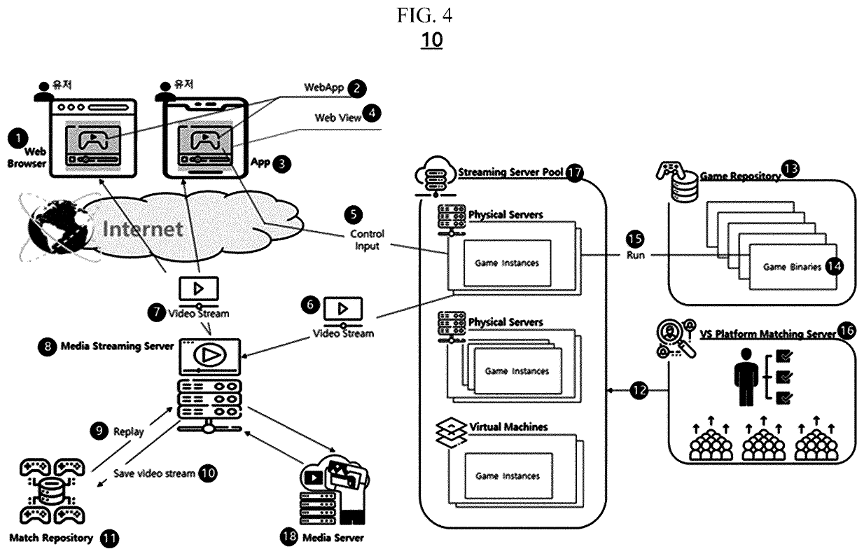

FIG. 4 is a diagram for explaining a streaming betting game system according to an embodiment.

Referring to FIG. 4, the streaming betting game system 10 according to an embodiment may include a streaming game cloud and a user device (i.e., a user) that receives game data streaming from the streaming game cloud. Here, the user device may include a web view module.

The streaming game cloud may provide game data to the user device. The game data to be provided to the user device may be stored in a game repository (“Game Repository”). In other words, streaming games may be stored in the game repository. For example, a developer who developed a game as a standalone app may separately create a streaming version and also store the streaming version in the game repository. To this end, an SDK may be provided to the developer.

The streaming game cloud may select a game for a match play from among games stored in the game repository. The selected game may be instantiated as a game instance (“Game Instance”), and the instantiated game may be encoded into a streaming game (i.e., a streaming image) through an internal streaming encoder (“BK Module's Encode”).

For encoding, an external streaming encoder (“External Encoder”) may be used instead of the streaming encoder. When the internal streaming encoder is an encoder implemented to be included in a game application during a development stage using the SDK, the external streaming encoder is intended to encode game into a streamable image even when the game application does not use the SDK.

The streaming game cloud may include a media streaming server, which may stream an encoded streaming game to the user device. The media streaming server may be implemented as a WebRTC streaming server. A streaming method is not limited to WebRTC, and may be implemented in any method that can be implemented by ordinary skill in the art to which the present invention pertains.

In some embodiments, the user may watch a game already in progress, bet or cheer for the game by using a separate game information page based on the streaming game cloud media streaming server without using a separate app. Cheer does not directly affect a game play, but may affect the player's psychology by exposing a cheering score to players.

The streaming game cloud may include a match repository (“Match Repository”), where play images of users may be stored. The play images stored in the match repository may be transmitted to the user device through the media streaming server. The play images stored in the match repository may be used for various purposes, for example, to show a game demo on the user device, may be provided according to a replay request that the user wishes to view, may be used to display a past play image along with a single play screen when the user plays a single play or a play image of another user, when the user is not playing a match with another user, but is playing a match with the past play image or the play image of another user, etc.

Meanwhile, the play images stored in the match repository may be used as evidence when a dispute regarding wins and losses or ranking arises. For evidence purpose, the play images stored in the match repository may be separately stored in a separate external storage medium.

Streaming play images may be stored in a match repository on a server to respond to a dispute that may arise in the future and may be used for replay.

In some embodiments, additional view configuration information may be necessary to efficiently configure a small screen. Therefore, when game images are recorded in the match repository, additional information for view configuration may be received from the game instance and stored as a separate metafile.

The media streaming server may stream only streaming games selected and instantiated from the game repository to the user device, or may stream play images stored in the match repository to the user device along with the streaming games.

In the latter case, the media streaming server may configure a screen including two or more images in a picture in picture or split screen format and then stream a configured final image to the user device.

Unlike this, the media streaming server may provide a plurality of images as respective separate streams to the user device. In this case, the user device may configure the plurality of images on one screen, and also stream metadata for view configuration along with the images.

The streaming game cloud may include a match platform that provides a match service (“Match Service”) to configure the match play between multiple users, and the match service may create a match between streaming games selected from among games stored in the game repository. The game instance for streaming match created as above may be executed in the streaming game cloud and streamed to user devices.

Specifically, streaming games may be created as many as the number of users participating in the match, and the match service may determine match start timing by considering a game environment of each user, for example, a transmission delay according to a network environment, etc.

In addition, in implementing cooperative competition, a streaming server has game instances, and thus, precise simultaneous start/stop, etc. are possible without a separate module, and an unfair game play due to differences in user hardware specifications may be prevented, which makes a fairer betting game between users possible.

For example, the match service may match users by using ELO rating, and may store users who can establish a match play based on the ELO rating in a pool and manage the users.

As another example, the match service periodically or aperiodically inspect a communication status between the user device and the streaming game cloud, a status of the user device, a status of the game instance, etc. from a game start stage, quantify status values, and use the status values to search for the optimal opponent.

Such a matching process may replace a function of correcting skill scores by matching players with similar latency.

In some embodiments, optimized matching through periodic or aperiodic communication with the streaming server may be utilized in a multidimensional manner, by considering even a game play and a streaming processing speed according to device specifications.

As an implementation example, the match service may select a target pool based on ELO points and select the optimal user from among users belonging to the selected target pool by considering a quantified game streaming status. Next, match information is notified to the selected user, and when there is a response from the user, matching is determined. When there is no response from the user, another optimal user belonging to the target pool may be selected.

In addition, through a practice play of a specific game, an appropriate score of the corresponding game only may be derived. To this end, an expected ability value for each game genre may be extracted by using a tester program that may measure gamer's capabilities. The tester program may include programs that may measure reaction speed of users, 3D spatial recognition abilities, numerical calculation speed, abilities to precisely control a controller, etc. However, quantifiable results do not only include values derived from the tester program.

When matching is determined, the match service may exchange information between selected users and initialize game statuses between the corresponding users to be the same (including time information synchronization). Also, the match service starts the game at the same time point within an error range between the users.

Thereafter, the match service may periodically or aperiodically verify whether there is an error in a time flow during the game, correct the error when there is the error, and determine a game result.

Meanwhile, the match service may interpret a part of a game streaming screen (for example, a part that shows a score, time, etc.) to determine the wins and losses or priority of the game.

In some embodiments, in order to stream a game targeted at a specific device in another type of device, a platform may change a game user input (UI) through a UI broker.

For example, in order to serve a game that can only be played with a mouse or gamepad to a mobile device, the UI broker may overlay a virtual gamepad on the game screen and convert a touch input that presses a button on the virtual gamepad into a button input on the gamepad to transmit the button input to the game, or convert a touch screen swipe input into a mouse movement input and transmit the mouse movement input to the game.

To this end, the UI broker may intervene in the game image and audio transmitted from the game instance to a video encoder, add necessary UI tasks to the video, and then transmit the video to the video encoder. In addition, the UI broker may first receive a game input that the user inputs through communication, convert the game input into an input of an input device of a type that the game supports, and transmit the input to the game instance.

In addition, the UI broker may translate letters displayed on the screen into a specific language and then draw translated text at the corresponding location, zoom in/out the game screen, or, but a task target not limited to the screen only, recognize sound and also create captions for the hearing impaired.

In the present embodiment, the user may access a game portal through a web browser or app. App may be customized and distributed to provide better accessibility than a web browser, and may have a built-in web view that serves the same function as the web browser. When the user access the game portal, a web app may run on the web browser, and the user may use all games and services on the web app.

In order to stream a game, a server to run the game is necessary. The platform matching server may search for a server in an idle state in the streaming server pool and request execution of a game instance. In this case, when hardware specifications required by the game are high, one physical server is entirely used, and when the hardware specifications are low, multiple games may run on one physical server or the games may run on a virtual machine (VM) to also efficiently provide services. When the server to run the game is ready, a game binary may be retrieved from the game repository and executed on the server.

The game image running in the game instance is encoded into a video stream through an encoder built into the game or a hardware encoder mounted on a server equipment and then transmitted to the media streaming server, and the media streaming server transmits the corresponding image to the user. In this case, according to a game type, a play image of another user or a past play image may be synthesized and transmitted.

In some embodiments, the media server may be used to process multiple game streaming data, camera data, etc. Tasks that are difficult to process with the hardware encoder mounted on the server equipment may be utilized in services by reprocessing images in a separate media server and retransmitting the processed images to the user and the match repository through the media streaming server.

The media streaming server may store the received images in a storage called the match repository, and the stored images may be used as evidence to resolve disputes related to the match. Alternatively, the stored images may be used for purposes such as replay or training for virtual competition at a user's request.

At least some of the functions described above may be provided to developers through the SDK. Accordingly, developers may use the SDK to create game application builds. For example, the SDK may be provided to implement a web view module for accessing the match platform (“BK Platform”), an encoding module for media transmission, a module for transmitting play information (e.g., a value of an acceleration sensor, a user input, etc.), etc.

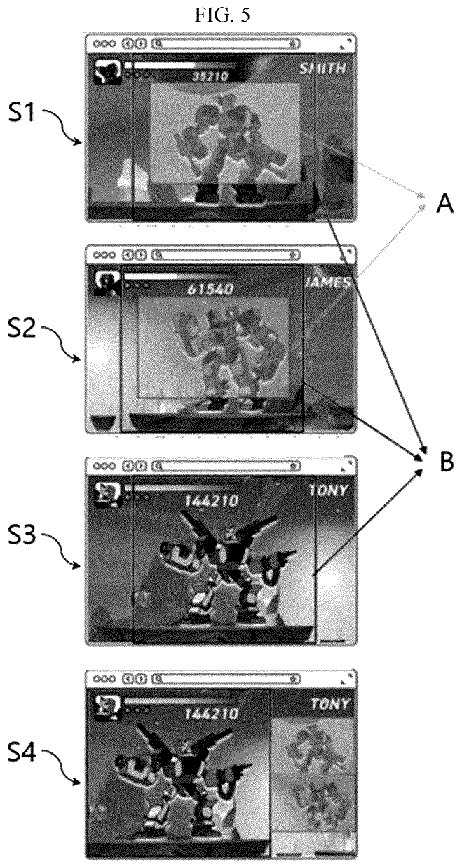

FIG. 5 is a diagram for explaining an operation of a streaming betting game system according to an embodiment.

In order to provide play images of other users to a game screen of a user device in a picture in picture or split screen format, a game development company may previously set a close-up area and a safe area. These areas may be fixed areas according to a game state, or may dynamically change according to a predetermined algorithm. For example, the game development company may set to show a more close-up area at a moment when an important event is about to occur.

Such area information may be stored as metadata along with images and used during replay.

In some embodiments, when a player view is provided, a player may receive images of the player and opposing players to configure the screen. When there are multiple opposing players, a network bandwidth is not sufficient, or a moving image decoding performance is insufficient, the media streaming server may previously configure a screen and then transmit the screen as a single video stream.

Referring to FIG. 5, S1 shows a screen of opposing player 1, and S2 shows a screen of opposing player 2. S3 shows a screen of the player during a single play, and S4 shows a screen of the player during a multiplayer. Areas marked with A in S1 and S2 may be areas created by an algorithm that a game creator has previously determined and need to be at least shared with other players. Areas marked with B in S1, S2, and S3 may be areas created by the algorithm that the game creator has previously determined and need to be seen by a player when playing the game. In other words, according to such configurations, the player may see close-up statuses of the opposing players (i.e., parts of S1 and S2) as much as possible simultaneously while seeing the screen S3 that the player needs to see.

In some embodiments, an image captured by a camera of each user may be reconfigured separately or together with the game data in streaming and shared with other users. This may be used to prevent an illegal play and may also be used as a means of communication between users.

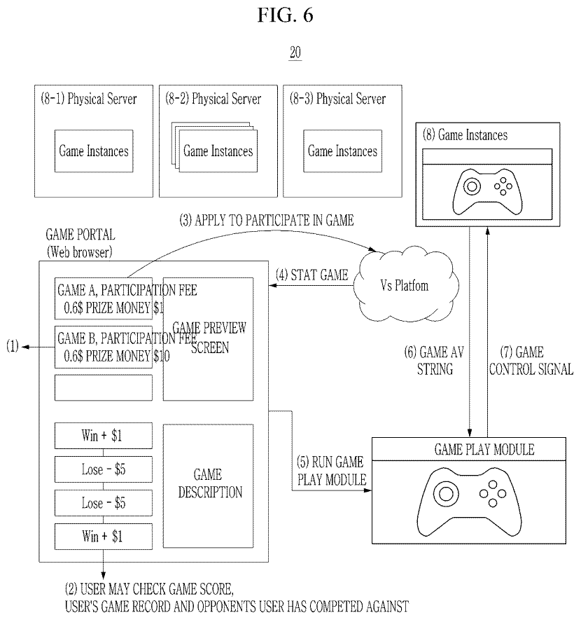

FIG. 6 is a diagram for explaining an operation of a streaming betting game system according to an embodiment.

Referring to FIG. 6, in a streaming betting game system 20 according to an embodiment, a user may execute a web browser or an app including the web view for a game play and access a game portal. When the user access the game portal, a portal web app (WebApp) runs in the web browser or the web view of the app. Subsequently, the user may select a game to play in the web app and move to a detailed page of the selected game. The user may check a list of open games, select a game that the user wants to participate in, and then click a button to pay a participation fee and apply to participate in the game.

The match platform (“Vs Platform”) may immediately create a game instance in a database and prepare the game instance when there is a real-time contender that meets the conditions, or when an asynchronous game is possible even though there is no contender. According to an amount of resources used by the game and hardware characteristics of a physical server, the game instance may entirely use the physical server, multiple game instances may be created on one physical server, or may be executed on a virtual machine. When the server is ready, the match platform may immediately retrieve the game from a game repository and run the game, i.e. create the game instance.

When the game instance is in a playable state, the match platform may notify the user of a match start, and the web app that receives a match start notification may run a game play module. The game play module may reproduce game audio and image received from the match platform and transmit an input of the user to the game instance through the match platform to enable a game play. When the game is over, the match platform may store match results in the database and transmit prize money to a winner.

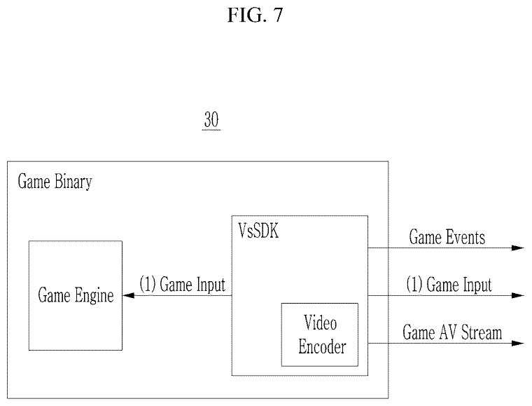

FIG. 7 is a diagram for explaining a streaming betting game system according to an embodiment.

Referring to FIG. 7, in a streaming betting game system 30 according to an embodiment, a game development company may configure an existing game into a game capable of streaming competition game by merely integrating an SDK (VsSDK) into the game. Specifically, the SDK may include an API that sends events necessary to proceed with a match, such as game start and end and score results, to the match platform, a module that transmits a game input received over a network to a game engine in the form of a device input such as a game pad, a streaming module that encodes and transmits a game screen and audio, etc.

Here, the streaming module may enable a streaming service even on a general-purpose server without separate hardware encoder equipment, and when a server has dedicated hardware streaming equipment, also utilize the dedicated hardware streaming equipment.

As described above, the game built by integrating the SDK may be stored in the game repository of the match platform through an inspection process, and when a user plays the game, may be loaded on the streaming server and instantiated as a game instance.

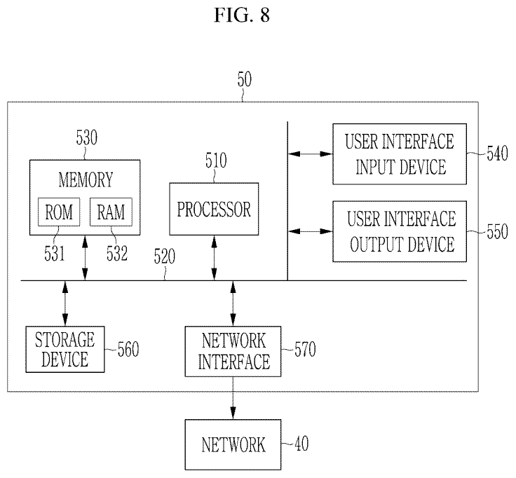

FIG. 8 is a diagram illustrating a computing device for implementing a streaming betting game system and method according to embodiments.

Referring to FIG. 8, the streaming betting game system and method according to embodiments may be implemented by using a computing device (or computer) 50.

The computing device 50 may include at least one of a processor 510, a memory 530, a user interface input device 540, a user interface output device 550, and a storage device 560 that communicate via a bus 520. The computing device 50 may also include a network interface 570 that is electrically connected to a network 40, such as a wired or wireless network. The network interface 570 may transmit or receive signals to and from other devices over the network 40.

The processor 510 may be implemented in various types such as an

Application Processor (AP), a Central Processing Unit (CPU), a Graphics Processing Unit (GPU), etc., and may be any semiconductor device that executes commands stored in the memory 530 or the storage device 560. The processor 510 may be configured to implement the functions and methods described with reference to FIGS. 1 to 7.

The memory 530 and the storage device 560 may include various types of volatile or non-volatile storage media. For example, the memory 530 may include read-only memory (ROM) 531 and random access memory (RAM) 532. In some embodiments, the memory 530 may be located inside or outside the processor 510, and the memory 530 may be connected to the processor 510 through various known means.

The streaming betting game system and method according to some embodiments may be implemented with a program or software executed in the computing device 50, and the program or software may be stored in a computer-readable medium.

The streaming betting game system and method according to some embodiments may be implemented with hardware that may be electrically connected to the computing device 50.

In some embodiments, at least some of the functions described above may be provided to developers through an SDK. Accordingly, developers may use the SDK to create game application builds.

According to the embodiments described above, by implementing a streaming game environment in which betting is possible by matching a plurality of users, a game immersion and interest of users playing games may be increased. In addition, through a streaming technology, users may enjoy betting games in various environments free from device-specific restrictions. In addition, because a service is provided through the streaming server, a natural match may be made even when a user downloads a game to a device that the user desires and when another user plays the game through streaming without downloading the corresponding game on the device, and thus, a game provider may provide in-game matching and results under fair conditions among users without the need for additional development according to different device environments.

Meanwhile, when providing betting (or competitive content) between users through the streaming game environment, an illegal play through hacking against a game client may be prevented. In addition, matching between users is made within a server and functions such as sharing matching results or providing rewards may be fairly performed, and thus, a content provider may be free from anxiety factors such as cheating in client modulation and matching between users.

Furthermore, for a streaming betting matching service, a fair match may be made based on a play environment (device specifications, latency, etc.) of a user and user matching and the analysis of user behavior patterns, etc. through the streaming match server system, and the results may be applied to a matching system of the server again to continuously provide fair betting matching without a fraudulent method.

Although the embodiments of the present invention have been described in detail above, the scope of the present invention is not limited thereto, and various modifications and improvements made by those of ordinary skill in the field to which the present invention pertains also belong to the scope of the present invention.

1. A streaming betting game method comprising:
configuring a user pool for creating a match play;
selecting a match play user who can establish the match play with a current user from the user pool;
creating a game instance from among games stored in a game repository;
streaming the game instance along with a play image of an opponent to the matched user; and
determining wins and losses or priority from game results and performing rewards.

2. The streaming betting game method of claim 1, further comprising:
storing additional information for view configuration received from the game instance as a separate metafile in a match repository; and
streaming play images stored in the match repository to a user device along with a streaming game.

3. The streaming betting game method of claim 2, wherein:
the streaming includes configuring a screen including two or more images in a picture in picture or split screen format; and
streaming a configured final image to the user device.

4. The streaming betting game method of claim 1, wherein:
the selecting of the match play user includes
selecting users who can establish a match play based on ELO rating.

5. The streaming betting game method of claim 4, wherein:
the selecting of the match play user includes
selecting a target pool based on ELO points and selecting an optimal user from among users belonging to the selected target pool by considering a quantified game streaming status.

6. The streaming betting game method of claim 1, wherein:
the streaming of the game instance along with the play image of the opponent includes
streaming the game instance along with statuses of a plurality of opposing players based on areas created by an algorithm that a game creator has previously determined and need to be at least shared with other players and areas created by the algorithm that the game creator has previously determined and need to be seen by a player when playing a game.

7. The streaming betting game method of claim 6, further comprising:
reconfiguring an image captured by a camera included in a user device of each user and sharing the reconfigured image with other users.

8. The streaming betting game method of claim 6, wherein:
the selecting of the match play user includes
periodically or aperiodically inspecting at least one of a communication status between a user device and a streaming game cloud, a status of the user device, a status of a game instance from a game start stage, and selecting an optimal opponent found by quantifying a status value as the match play user.

9. The streaming betting game method of claim 8, wherein:
the selecting of the match play user includes
correcting skill scores by matching players with similar latency.

10. A computer-readable medium recording a program on a computer for executing:
configuring a user pool for creating a match play;
selecting a match play user who can establish the match play with a current user from the user pool;
creating a game instance from among games stored in a game repository;
streaming the game instance along with a play image of an opponent to the matched user; and
determining wins and losses or priority from game results and performing rewards.
